(19) United States
(12) Patent Application Publication
(10) Pub. No.: US 2024/0222733 A1
(43) Pub. Date: Jul. 4, 2024

(54) METHOD FOR EXTRACTING VALUABLE METALS FROM BATTERY WASTE

(71) Applicant: OXLEIGH RECYCLING TECHNOLOGIES PTY LTD, New South Wales (AU)

(72) Inventors: Mobin NOMVAR, New South Wales (AU); Shane Joseph COX, New South Wales (AU); Victor Cheuk-Kit LO, New South Wales (AU)

(73) Assignee: OXLEIGH RECYCLING TECHNOLOGIES PTY LTD, New South Wales (AU)

(21) Appl. No.: 18/392,375

(22) Filed: Dec. 21, 2023

(30) Foreign Application Priority Data
Dec. 23, 2022 (AU) 2022904001

(51) Int. Cl. H01M 10/54; C22B 1/06; C22B 3/02; C22B 3/22; C22B 7/00

(52) U.S. Cl. CPC H01M 10/54; C22B 1/06; C22B 3/02; C22B 3/22; C22B 7/006

(57) ABSTRACT

According to the present invention there is provided a method for the extraction of one or more valuable metals, preferably Li, Co, Mn and/or Ni, from black mass end-of-life battery waste, the method comprising the steps of: obtaining the black mass having a content of the one or more valuable metals; subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material; and converting the sulfur/metal roasted material to its respective metal sulfate/s by subjecting the sulfur/metal roasted material to an extraction medium defined by an excess of water, a flow of air, at a second predetermined temperature, at a second predetermined heated pressure over a second predetermined period.

### RELATED APPLICATION

This application claims convention priority from Australian Provisional Patent Application No. 2022904001, filed on 23 Dec. 2022. The content of AU'001 is incorporated herein by reference in its entirety.

### FIELD OF THE INVENTION

The present invention relates to a method of extracting valuable battery materials and/or valuable metals, such as cobalt, manganese, nickel, lithium, etc., from end-of-life batteries. In particular, the invention describes a method for converting valuable metals present in black mass, such as cobalt, manganese, nickel, lithium, etc., to the respective metal sulfide and/or metal sulfates as part of the battery recycling process. Specifically, the reactions are conducted within a pressurised vessel in the presence of sulfur, water and black mass materials.

Although the present invention will be described hereinafter with reference to its preferred embodiment, it will be appreciated by those skilled in the art that the spirit and scope of the invention may be embodied in many other forms.

### BACKGROUND OF THE INVENTION

Any discussion of the prior art throughout the specification should in no way be considered as an admission that such prior art is widely known or forms part of common general knowledge in the field.

Valuable metals are mined from their constituent ores at an exponentially-increasing rate. With the overall supply being strictly finite, some metals are already under supply and sustainability pressure. Without increased adoption of recycling practices, the global supply of certain metals will inevitably extinguish long before consumer demand subsides. Examples of such metals include nickel, manganese, cobalt and lithium.

Cobalt's value resides principally in its utility across industries such as alloys, batteries, catalysis, pigments, radioisotopes, electroplating and porcelain enamels.

Nickel is used across many industrial and consumer products including stainless steel, alnico magnets, coinage, rechargeable batteries (e.g., nickel-iron), electric guitar strings, microphone capsules, plating on plumbing fixtures and special alloys such as permalloy, elinvar, and invar. It is widely used in many other alloys, including nickel brasses and bronzes and alloys with copper, chromium, aluminium, lead, cobalt, silver, and gold.

Manganese is applied industrially across steelmaking, alloying, batteries, resistors, minting and ceramic colourings.

At an industrial level, lithium is assuming ever-increasing popularity given its many uses: ceramics, glasses, batteries, electronics, lubricating greases, metallurgy, pyrotechnics, air purification, optics, polymer chemistry, military applications and medicine—to name but a few. One of the principal uses of lithium is in batteries—and demand will only continue to grow as (amongst other emerging technologies) all-electric vehicles take to the roads over the next few years. Lithium is especially amenable to use in batteries owing to its high electrode potential (the highest of all metals) and its low atomic mass, which leads to high charge-to-weight and power-to-weight ratios. Lithium batteries are preferred over other batteries due to their relatively high charge density (long life), but presently suffer from a relatively high cost per unit. Depending on the design and chemical compounds used, lithium cells can produce voltages from 1.5 V (comparable to a zinc-carbon or alkaline battery) to about 3.7 V.

With society's ever-increasing environmental consciousness and demand for battery power as an alternative to fossil fuels comes the inevitability of new waste streams for spent batteries. However, a further inevitability of this mindset working in unison with such waste streams has been a surge in recycling technologies in which, for instance, at least some of the valuable metals contained within spent batteries are recovered and recycled for future use.

It is estimated that by 2030, around 1.2 million tons of lithium ion batteries will have reached end-of-life. This comprises an estimated potential recovery of 125,000 tons of lithium, 35,000 tons of cobalt and 86,000 tons of nickel, which could be recovered for use in new battery production. Such numbers must be considered against the fact that global supply of such elements is strictly finite and absent effective recycling practices, the technology span of lithium ion batteries may be limited by supply rather than by the emergence of new and better battery technologies.

“Black mass” is the industry term used to describe a type of e-waste comprising crushed and shredded end-of-life battery cells. It contains a mixture of valuable metals including lithium, manganese, cobalt, nickel along with graphite and other casing or electrode materials. Initially, waste batteries are collected, sorted, discharged, disassembled and crushed to provide “raw” black mass. The raw black mass then optionally undergoes any one or more of drying, sorting sieving and pyrolysis to 700° C. to remove at least some of any remaining electrolyte and potentially hazardous to health fluorine-containing components. The resulting material is what is referred to in the battery recycling industry as “treated” black mass.

In traditional battery recycling, metals are typically extracted in the last step or after significant processing. Examples include hydrometallurgy and pyrometallurgy. Hydrometallurgy (see, e.g., Wang, H., Friedrich, B. Development of a Highly Efficient Hydrometallurgical Recycling Process for Automotive Li-Ion Batteries. J. Sustain. Metall. 1, 168-178, 2015) refers to the extraction of metal by preparing an aqueous solution of a salt of the metal and recovering the metal from the solution. The operations usually involved are leaching, or dissolution of the metal or metal compound in water, commonly with additional agents; separation of the waste and purification of the leach solution; and the precipitation of the metal or one of its pure compounds from the leach solution by chemical or electrolytic means. Common leaching agents include sulfuric acid, hydrochloric acid and hydrogen peroxide, etc. Multiple steps are required and significant wastewater is produced.

Pyrometallurgy (see, e.g., Assefi, et al., Pyrometallurgical recycling of Li-ion, Ni—Cd and Ni-MH batteries: A minireview, Current Opinion in Green and Sustainable Chemistry, 24, 26-31, 2020) refers to the extraction and purification of metals by processes involving the application of heat. The most important operations are roasting, smelting, and refining. Such processes are extremely energy-intensive, consume many environmentally-harmful chemicals and result in the generation of hazardous gases.

Recovery of valuable metals from black mass by traditional hydrometallurgical or pyrometallurgical means thereby comes at a considerable environmental and consequently financial cost. Unsurprisingly, several alternative technologies have emerged in recent years.

CN 113415813, to Sichuan Changhong Gerun Environmental Protection Tech Co. Ltd., CN 111333123 A, to Univ. Central South, and CN 114480854 A, to Hunan New Energy Battery Mat Stock Limited Company, each describe a method for the extraction of one or more valuable metals from black mass end of-life battery waste, the method comprising the steps of a) obtaining the black mass having a content of the one or more valuable metals; b) subjecting the black mass to a hydrothermal extraction medium defined by molar excess of sulfuric acid, a first predetermined temperature and a first predetermined heated pressure, over a first predetermined period to provide a sulfur/metal roasted material; and c) converting the sulfur/metal roasted material to its respective metal sulfate/s by subjecting the sulfur/metal roasted material to an extraction medium defined by an excess of water, a flow of air, at a second predetermined temperature, at a second predetermined heated pressure over a second predetermined period. However, each of these three documents fails to disclose or teach subjecting the black mass to a hydrothermal extraction medium defined by a molar excess of molten elemental sulfur and a predetermined amount of water.

WO 2022/045973, to Green Li-Ion Pte. Ltd., describes a method of treating a leaching solution derived from a black mass from spent lithium-ion batteries comprising setting pH of the leaching solution to about pH 1.2 to 2.5, adding iron powder to induce copper cementation, adding lime after copper cementation, and after adding lime, transiting pH of the leaching solution to about pH 6 to extract calcium fluoride, titanium hydroxide, aluminium hydroxide, iron hydroxide, and iron phosphate. A black mass recycling system comprising an impurity removal reactor configured to receive a sodium hydroxide feed, an iron powder feed, and a lime feed.

Conventional recycling plants appear focused on particular metals, such as cobalt and often ignore other valuable metals, such as manganese and nickel. Generally, these plants are not equipped to handle different types of LIBs and the impurities introduced.

It is an object of the present invention to overcome or ameliorate at least one of the disadvantages of the prior art, or to provide a useful alternative.

It is an object of a particularly preferred form of the present invention to provide for an extraction process which can recycle valuable metals and/or materials from black mass. Most preferably, the valuable metals are selected from the group consisting of cobalt, nickel, manganese and lithium.

It is an object of an especially preferred form of the invention to use molten elemental sulfur to recycle valuable metals from the black mass of spent lithium-ion batteries into fresh cathode material. This requires the chemical conversion of metal oxides from the black mass of spent lithium-ion batteries into metal sulfates that could be used to manufacture new cathodes. There is an emphasis on recycling nickel, manganese and cobalt which are the three constituents of NMC-type lithium-ion batteries alongside lithium itself (e.g., Equations 1-3). Limitations were placed on the operating conditions to ensure the technology remained competitive with other established or in development technologies, such as the process of WO 2022/045973, as described above, which centres on the use of high quantities of concentrated acid. These limitations included maintaining the operating temperature below 400° C. and the operating pressure below 20 bar.

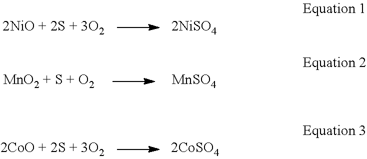

Although the invention will be described with reference to specific examples it will be appreciated by those skilled in the art that the invention may be embodied in many other forms.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

As defined above, “black mass” refers to, essentially, crushed end-of-life battery materials. For the avoidance of doubt, the black mass subject of the present invention is preferably “raw” black mass of the cathode materials which typically comprises binders, lithium metal oxide and aluminium. It may be optionally treated (for example, by pyrolysis, to remove the battery electrolytes, or sodium hydroxide leaching and sonication to remove aluminium). The economic potential of a recycling method that if efficacious despite avoiding expensive pre-treatment step/s is clear.

“Valuable metals” refers to any metal that may be present in the black mass, including, not limited to, one or more of Li, Au, Ag, Al, Ca, Cr, Co, Cu, Fe, Ga, K, Mg, Mn, Na, Ni, and V.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “molar %”, “ratio” will mean “molar ratio” and “parts” will mean “molar parts”.

The term “substantially” as used herein shall mean comprising more than 50% by weight, where relevant, unless otherwise indicated.

The term “about” should be construed by the skilled addressee having regard to normal tolerances in the relevant art.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The prior art referred to herein is fully incorporated herein by reference unless specifically disclaimed.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

This specification is prepared having regard to the principles of general application. As such, where the specification discloses a principle of general application, the claims may be drafted in correspondingly general terms (Biogen v Medeva [1997] RPC 1 at 48). A “principle of general application” is a general principle that can be practically applied in making a class of products, or in working a process, including where the claims define the products or process(es) in terms of the result to be achieved.

A feature in the claims stated in general terms will represent a principle of general application, where it is reasonable to expect (reasonable to predict) that the claimed invention will work with anything that falls within the general term. Such a feature defined in general terms may be a major part of the claim, or it may be a simple descriptive word. In either case, a feature in the claims expressed in general terms will be sufficiently enabled if the disclosure enables at least one form of, or one application of, a general principle in respect of the feature, and the person skilled in the art would reasonably expect the invention to work with anything that falls within the general term. (Kirin-Amgen Inc. v Hoechst Marion Roussel Ltd [2005] RPC 9 at [112]).

Where the claims are more broadly drafted they may be considered enabled if, prima facie: a) the disclosure teaches a principle that the person skilled in the art would need to follow in order to achieve each and every embodiment falling within a claim; and b) the specification discloses at least one application of the principle and provides sufficient information for the person skilled in the art to perform alternative applications of the principle in a way that, while not explicitly disclosed, would nevertheless be obvious to the person skilled in the art (T484/92).

Unless indicated otherwise, the term “purity” is referenced on a molar basis.

### SUMMARY OF EMBODIMENTS OF THE INVENTION

According to a first aspect of the present invention there is provided a method for the extraction of one or more valuable metals from black mass end-of-life battery waste, the method comprising the steps of:
a) obtaining the black mass having a content of the one or more valuable metals;
b) subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material; and
c) converting the sulfur/metal roasted material to its respective metal sulfate/s by subjecting the sulfur/metal roasted material to an extraction medium defined by an excess of water, a flow of air, at a second predetermined temperature, a second predetermined heated pressure over a second predetermined period.

In a preferred embodiment, step b) is conducted at about 200° C., 5 bar starting pressure, 2 h period and with 1.9 molar equivalents of water.

In a preferred embodiment, step c) is conducted at about 150° C., 5 bar starting pressure, 3 h period, 8 molar equivalents of water and 100 SCCM air flow.

In another preferred embodiment, steps b) and c) are performed simultaneously, thereby allowing either a single-step reaction or a one-pot reaction where additional water is introduced after a defined time.

In another preferred embodiment, steps b) and c) are performed as discrete steps either in the same reactor, or in a separate reactor.

In an embodiment, the metal sulfate/s is/are collected and filtered for further processing.

In an embodiment, the further processing comprises converting the metal sulfate/s to their respective elemental metal via conventional techniques.

In an embodiment, the hydrothermal extraction medium in step b) is further defined by stirring at a rate of about 10 to 2000 rpm, preferably about 50 to 500 rpm and more preferably about 100 rpm.

In various embodiments, the hydrothermal extraction medium in step b) is further defined by stirring at a rate of about 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 rpm. In other embodiments, the rate of stirring may be greater than 500 rpm.

In an embodiment, the extraction medium in step b) is further defined by stirring at a rate of about 50 to 500 rpm, preferably about 100 rpm.

In various embodiments, the extraction medium in step c) is further defined by stirring at a rate of about 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or 500 rpm. In other embodiments, the rate of stirring may be greater than 500 rpm.

In an embodiment, the molar excess of molten elemental sulfur is between about 2:1 and 25:1, preferably about 5:1.

In various embodiments, the molar excess of molten elemental sulfur is about 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, or 25:1.

In an embodiment, the predetermined amount of water is between about 0.1:1 and 1:1 by mass, preferably about 0.5:1.

In various embodiments, the predetermined amount of water is about 0.1:1, 0.2:1, 0.3:1, 0.4:1, 0.5:1, 0.6:1, 0.7:1, 0.8:1, 0.9:1, or 1:1.

In a particularly preferred embodiment, the molar ratio of water to metal oxide reagent is about 1.9:1. In another particularly preferred embodiment, the reaction was performed with a 5:1:1.9 molar ratio of sulfur to metal oxide to water.

In an embodiment, the first predetermined temperature as defined in step b) is between about 100 and 400° C., preferably about 200° C.

In an embodiment, the defined temperature range is intended to encompass the stated endpoints and all temperatures therebetween. As such, the claimed range includes extraction temperatures of 100, 105, 110, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395 and 400° C., including intermediary values such as 141, 142, 143, 144, 146, 147, 148, 149, 151, 152, 153, 154, 156, 157, 158 and 159° C., etc.

In a preferred embodiment, the first predetermined temperature is between about 100° C. and about 400° C. In another preferred embodiment, the first predetermined temperature is between about 120° C. and about 380° C. In another preferred embodiment, the first predetermined temperature is between about 140° C. and about 360° C. In another preferred embodiment, the first predetermined temperature is between about 160° C. and about 340° C. In another preferred embodiment, the first predetermined temperature is between about 180° C. and about 320° C. In another preferred embodiment, the first predetermined temperature is about 200° C.

In an embodiment, the first predetermined heated pressure is above atmospheric pressure.

In an embodiment, the first predetermined heated pressure is between about 5 and 100 bar, preferably between about 5 and 40 bar, and more preferably about 15 bar.

In various embodiments, the first predetermined heated pressure is about 5, 10, 15, 20, 25, 30, 35, 40, 45, 50, 55, 60, 65, 701, 75, 80, 85, 90, 95 or 100 bar.

In various embodiments, the first predetermined heated pressure is between about 5 and 100 bar. In other embodiments, the first predetermined heated pressure is between about 6 and 90 bar. In other embodiments, the first predetermined heated pressure is between about 7 and 80 bar. In other embodiments, the first predetermined heated pressure is between about 8 and 70 bar. In other embodiments, the first predetermined heated pressure is between about 9 and 60 bar. In other embodiments, the first predetermined heated pressure is between about 10 and 50 bar. In other embodiments, the first predetermined heated pressure is between about 11 and 40 bar. In other embodiments, the first predetermined heated pressure is between about 12 and 30 bar. In other embodiments, the first predetermined heated pressure is between about 13 and 25 bar. In other embodiments, the first predetermined heated pressure is between about 14 and 20 bar. In other embodiments, the first predetermined heated pressure is about 15 bar.

In an embodiment, the first predetermined period in step b) is between about 15 and 300 minutes, preferably about 60 to 180 minutes, most preferably about 120 minutes.

In various embodiments, the first predetermined period in step b) is about 15, 20, 30, 40, 50, 60, 70, 80, 90, 100, 110, 120, 130, 140, 150, 160, 170,180, 190, 200, 210, 220, 230, 240, 250, 260, 270, 280, 290 or 300 minutes.

In other embodiments, the first predetermined period in step b) is between about 60 and 180 minutes. In other embodiments, the first predetermined period in step b) is between about 70 and 170 minutes. In other embodiments, the first predetermined period in step b) is between about 80 and 160 minutes. In other embodiments, the first predetermined period in step b) is between about 90 and 150 minutes. In other embodiments, the first predetermined period in step b) is between about 100 and 140 minutes. In other embodiments, the first predetermined period in step b) is between about 110 and 130 minutes. In other embodiments, the first predetermined period in step b) is about 120 minutes.

In an embodiment, the excess of water in step c) is between about 2:1 and 25:1, preferably about 5:1 to 10:1, and most preferably about 8:1 on a molar ratio of water to sulfur/metal roasted material basis.

In various embodiments, the excess of water in step c) is about 5:1, 6:1, 7:1, 8:1, 9:1 or 10:1 on a molar ratio of water to sulfur/metal roasted material basis

In an embodiment, the second predetermined temperature in step c) is between about 100 and 400° C., preferably about 150° C. to about 200° C.

In a preferred embodiment, the second predetermined temperature is between about 100° C. and about 200° C. In another preferred embodiment, the second predetermined temperature is between about 120° C. and about 280° C. In another preferred embodiment, the second predetermined temperature is between about 140° C. and about 260° C. In another preferred embodiment, the second predetermined temperature is between about 160° C. and about 240° C. In another preferred embodiment, the second predetermined temperature is between about 180° C. and about 220° C. In another preferred embodiment, the second predetermined temperature is about 150° C.

In various embodiments, the defined temperature range is intended to encompass the stated endpoints and all temperatures there-between. As such, the claimed range includes extraction temperatures of 100, 105, 110, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395 and 400° C., including intermediary values such as 141, 142, 143, 144, 146, 147, 148, 149, 151, 152, 153, 154, 156, 157, 158 and 159° C., etc.

In an embodiment, the second predetermined heated pressure is between about 1 and 100 bar, preferably between about 1 and 20 bar, and more preferably about 5 bar.

In various embodiments, the first predetermined heated pressure is about 1, 2, 3, 4, 5, 6, 7, 8, 9, 10, 11, 12, 13, 14, 15, 16, 17, 18, 19, 20, 25, 30, 35, 40, 45, 50, 55, 60, 65, 701, 75, 80, 85, 90, 95 or 100 bar.

In various embodiments, the first predetermined heated pressure is between about 1 and 100 bar. In other embodiments, the first predetermined heated pressure is between about 1 and 90 bar. In other embodiments, the first predetermined heated pressure is between about 2 and 80 bar. In other embodiments, the first predetermined heated pressure is between about 2 and 70 bar. In other embodiments, the first predetermined heated pressure is between about 3 and 60 bar. In other embodiments, the first predetermined heated pressure is between about 3 and 50 bar. In other embodiments, the first predetermined heated pressure is between about 3 and 40 bar. In other embodiments, the first predetermined heated pressure is between about 4 and 30 bar. In other embodiments, the first predetermined heated pressure is between about 4 and 25 bar. In other embodiments, the first predetermined heated pressure is between about 4 and 20 bar. In other embodiments, the first predetermined heated pressure is between about 4 and 15 bar. In other embodiments, the first predetermined heated pressure is between about 4 and 10 bar. In other embodiments, the first predetermined heated pressure is about 5 bar.

In an embodiment, the second predetermined period in step c) is between about 30 and 300 minutes, preferably between about 120 and 240 minutes and most preferably about 180 minutes.

In various embodiments, the second predetermined period in step c) is about 30, 40, 50, 60, 70, 80, 90, 100, 110, 120, 130, 140, 150, 160, 170, 180, 190, 200, 210, 220, 230, 240, 250, 260, 270, 280, 290 or 300 minutes.

In other embodiments, the second predetermined period in step c) is between about 60 and 180 minutes. In other embodiments, the second predetermined period in step c) is between about 70 and 170 minutes. In other embodiments, the second predetermined period in step c) is between about 80 and 160 minutes. In other embodiments, the second predetermined period in step c) is between about 90 and 150 minutes. In other embodiments, the second predetermined period in step c) is between about 100 and 140 minutes. In other embodiments, the second predetermined period in step c) is between about 110 and 130 minutes. In other embodiments, the second predetermined period in step c) is about 120 minutes.

In an embodiment, step b) and step c) are conducted in a single vessel.

In an embodiment, step b) and step c) are conducted in separate vessels, optionally operatively connected to enable substantially continuous operation.

In an embodiment, the method employs a plurality of vessels arranged in series or parallel.

In an embodiment, the method employs a plurality of vessels arranged in series.

In an embodiment, the method employs a plurality of vessels arranged in parallel.

In an embodiment, the method is adaptable and/or scalable to a continuous flow or batch-type scenario.

In an embodiment, the one or more valuable metals comprise Li, Au, Ag, Al, Ca, Cr, Co, Cu, Fe, Ga, K, Mg, Mn, Na, Ni, and V.

In an embodiment, the one or more valuable metals comprise Li, Al, Mn, Co, and Ni.

In an embodiment, the one or more valuable metals comprise Li, Mn, Co, and Ni.

In an embodiment, the one or more valuable metals comprises Li.

In an embodiment, the one or more valuable metals comprises Mn.

In an embodiment, the one or more valuable metals comprises Co.

In an embodiment, the one or more valuable metals comprises Ni.

In an embodiment, the method gives rise to a yield (on an extracted valuable metals basis) of between about 1% and about 99%.

In an embodiment, the hydrothermal extraction medium is defined by a black mass concentration between about 0.1 and about 60% w/w.

The black mass concentration equates to the weight/weight percentage of battery waste solids within the aqueous (i.e., water) solution. The black mass concentration is between about 0.1% w/w and about 60% w/w. As such, the claimed range includes 0.1, 1, 2, 4, 6, 8, 10, 12, 14, 16, 18, 20, 22, 24, 26, 28, 30, 32, 34, 36, 38, 40, 42, 44, 46, 48, 50, 52, 54, 56, 58 and 60% w/w, including intermediary values such as 21, 23, 25, 27, 29, 31, 33, 35, 37 and 39% w/w.

In a preferred embodiment, the black mass concentration is between about 0.1 and about 60% w/w. In another preferred embodiment, the black mass concentration is between about 1 and about 55% w/w. In another preferred embodiment, the predetermined solids concentration is between about 5 and about 50% w/w. In another preferred embodiment, the predetermined solids concentration is between about 10 and about 40% w/w. In another preferred embodiment, the black mass concentration is between about 20 and about 35% w/w. In another preferred embodiment, the black mass concentration is about 30% w/w.

In a preferred embodiment, the black mass concentration is between about 0.1 and about 60% w/w. In another preferred embodiment, the black mass concentration is between about 0.1 and about 55% w/w. In another preferred embodiment, the black mass concentration is between about 0.1 and about 50% w/w. In another preferred embodiment, the black mass concentration is between about 0.1 and about 40% w/w. In another preferred embodiment, the black mass concentration is between about 0.1 and about 35% w/w.

In a preferred embodiment, the black mass concentration is between about 0.1 and about 60% w/w. In another preferred embodiment, the black mass concentration is between about 1 and about 60% w/w. In another preferred embodiment, the black mass concentration is between about 5 and about 60% w/w. In another preferred embodiment, the black mass concentration is between about 10 and about 60% w/w. In another preferred embodiment, the black mass concentration is between about 20 and about 60% w/w.

In an embodiment, the black mass has an average particle size between about 0.1 μm and about 1000 μm.

In an embodiment, the black mass has an average particle size between about 500 nm and about 500 μm. In preferred embodiments, the black mass has an average particle size between about 40 and 60 μm. Most preferably, the black mass has an average particle size between about 44 μm.

In an embodiment, the black mass has an average particle size of about 500, 1000, 1500, 2000, 2500, 3000, 3500, 4000, 4500, 5000, 5500, 6000, 6500, 7000, 7500, 8000, 8500, 9000, 9500 or 10,000 nm (i.e., 10 μm). In an embodiment, the black mass has an average particle size of about 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490 or about 500 μm.

In an embodiment, the black mass has an average particle size between about 500 nm and about 500 μm. In a preferred embodiment, the black mass has an average particle size between about 2000 nm and about 450 μm. In a preferred embodiment, the black mass has an average particle size between about 4000 nm and about 400 μm. In a preferred embodiment, the black mass has an average particle size between about 6000 nm and about 350 μm. In a preferred embodiment, the black mass has an average particle size between about 8000 nm and about 300 μm. In a preferred embodiment, the black mass has an average particle size between about 10,000 nm and about 250 μm. In a preferred embodiment, the black mass has an average particle size between about 12,000 nm and about 200 μm. In a preferred embodiment, the black mass has an average particle size between about 14,000 nm and about 150 μm. In a preferred embodiment, the black mass has an average particle size between about 16,000 nm and about 100 μm. In a preferred embodiment, the black mass has an average particle size between about 20,000 nm and about 90 μm. In a preferred embodiment, the black mass has an average particle size between about 25,000 nm (i.e., 25 μm) and about 80 μm. In a preferred embodiment, the black mass has an average particle size between about 30 μm and about 70 μm. In a preferred embodiment, the black mass has an average particle size between about 35 μm and about 60 μm. In a preferred embodiment, the black mass has an average particle size of about 44 μm. Without wishing to be bound by theory, the Inventors believe that smaller particle sizes tend toward lithium, manganese, cobalt and nickel extraction or other valuable metals with a similar molecular size and/or chemical valence, whereas larger black mass particles provide for the selective extraction of other valuable metals such as aluminium.

The average particle size of the black mass is between about 500 nm and about 500 μm, more preferably, between about 40 μm and about 60 μm, and most preferably about 44 μm. This defined range is intended to encompass the stated endpoints and all average particle sizes therebetween. As such, the claimed range includes 0.5 μm (i.e., 500 nm), 1, 20, 40, 60, 80, 100, 120, 140, 160, 180, 200, 220, 240, 260, 280, 300, 320, 340, 360, 380, 400, 420, 440, 460, 480 and 500 μm, including intermediary values such as 61, 62, 63, 64, 65, 66, 67, 68, 69, 70, 71, 72, 73, 74, 75, 76, 77, 78, 79, 81, 82, 83, 84, 85, 86, 87, 88, 89, 90, 91, 92, 93, 94, 95, 96, 97, 98 and 99 μm, etc.

In an embodiment, one or more metal impurities extracted from the black mass comprise Au, Ag, Al, Ca, Cr, Cu, Fe, Ga, K, Mg, Na, Si, and V.

In an embodiment, any one or more of the metal impurities is present at a concentration between about 0.5% and about 40% of the valuable metals concentration on a molar basis.

In an embodiment, the hydrothermal medium further comprises one or more mineral acids, one or more organic acids, one or more alkaline salts, one or more ionic liquids, and combinations thereof.

In an embodiment, the black mass is “raw” black mass as defined above.

In an embodiment, the black mass is “treated” black mass as defined above.

In an embodiment, electrolytes from a battery are still present in the black mass.

In an embodiment, the black mass may comprise one or more of a binder or electrolyte. Preferably the electrolyte is lithium hexafluorophosphate (LiPF₆). Preferably, the binder is selected from one or more of fluoroethylene carbonate (FEC), 1,3-propane sultone (PS), dimethyl carbonate (DMC), ethyl methyl carbonate (EMC), ethylene carbonate (EC), polyvinylidene fluoride (PVDF) or propylene carbonate (PC).

In an embodiment, the method is performed on a continuous or semi-continuous basis. Semi-continuous operation may involve a batch-type process whereby each batch is run in a semi-continuous process. This could be achieved in a plurality of reactors each operating independently of the other or in fluid communication with each other such that each batch is run with an increasing concentration of valuable metals in solution as it is passed through each reactor. The term “batch” should be understood to include fixed bed, fluidised bed or moving bed reactors.

In an embodiment, the inventive method gives rise to a yield (on an extracted valuable metals basis) of between about 1% and about 99%.

In a preferred embodiment, the inventive method gives rise to a yield (on an extracted valuable metals to black mass basis) of between about 1% and about 99%. Preferably, the yield is between about 10% and about 95%. More preferably, the yield is between about 25% and about 90%. More preferably, the yield is between about 50% and about 85%. More preferably, the yield is about 75%.

This defined range of about 1 to about 99% is intended to encompass the stated endpoints and all yields therebetween. As such, the claimed range includes 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 81, 82, 83, 84, 85, 86, 87, 88, 89, 90, 91, 92, 93, 94, 95, 96, 97, 98 and 99% on an extracted valuable metals to black mass basis, including intermediary values such as 70.5, 71.5, 72.5, 73.5, 74.5, 75.5, 76.5, 77.5, 78.5, 79.5 and 80.5% on an extracted valuable metals to black mass basis.

In an embodiment, one or more impurities extracted from the black mass comprise Ag, Au, Na, K, Mg, Ca, Fe, Al, and Si.

In an embodiment, any one or more of the impurities is present at a concentration between about 0.5% and about 40% of the black mass concentration on a w/w basis.

In an embodiment, the inventive method is adaptable and/or scalable to a continuous flow or batch-type scenario.

In an embodiment, the aqueous medium comprises water, one of more mineral acids, one or more organic acids, one or more alkaline salts, one or more ionic liquids, and combinations thereof.

In another preferred embodiment, the one or more organic acids are selected from the group consisting of acetic acid, citric acid, lactic acid, oxalic acid, and the like. Preferably, the one or more organic acids are present in concentrations ranging from dilute to concentrated.

According to a second aspect of the present invention there is provided one or more valuable metals, when extracted from black mass end-of-life battery waste by a method as defined according to the first aspect of the present invention.

According to a third aspect of the present invention there is provided an apparatus for the extraction of one or more valuable metals from black mass end-of-life battery waste, the apparatus comprising:
a) means for subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material; and
b) means for converting the sulfur/metal roasted material to its respective metal sulfate/s by subjecting the sulfur/metal roasted material to an extraction medium defined by an excess of water, a flow of air, at a second predetermined temperature, at a second predetermined heated pressure over a second predetermined period.

In an embodiment, the one or more valuable metals comprises one or more of Li, Au, Ag, Al, Ca, Cr, Co, Cu, Fe, Ga, K, Mg, Mn, Na, Ni, and V.

In an embodiment, the one or more valuable metals comprises one or more of Li, Al, Mn, Co, and Ni.

In an embodiment, the one or more valuable metals comprises one or more of Li, Mn, Co, and Ni.

In an embodiment, the one or more valuable metals comprise Ni.

In an embodiment, the one or more valuable metals comprise Mn.

In an embodiment, the one or more valuable metals comprise Co.

In an embodiment, the one or more valuable metals comprise Li.

In another preferred embodiment, the respective extracted metal sulfates undergo a concentration step; the concentration step can be any standard concentration techniques of the art, including but not limited to: the addition of a concentrator, evaporation, reverse osmosis, electrodialysis, liquid-liquid extraction, selective adsorption and solid state extraction and/or membrane separation. In another preferred embodiment, the purification may be effected by precipitation.

In an embodiment, the apparatus comprises a plurality of reactors arranged in fluid communication in series.

In an embodiment, the apparatus comprises a plurality of reactors arranged in fluid communication in parallel.

In a preferred embodiment, the apparatus further comprises means for effecting an initial milling step, whereby the black mass is milled to a predetermined average particle size (as defined above) prior to being provided to step a).

In a preferred embodiment, the apparatus further comprises means for concentrating the respective metal sulfates obtained in solution following exposure to the extraction medium.

In a preferred embodiment, the inventive apparatus further comprises filtration means, for filtering off any precipitated respective metal sulfate following exposure to the concentration means.

In an embodiment, the one or more respective metal sulfates comprises one or more of Li, Mn, Co and Ni.

In an embodiment, the one or more respective metal sulfates comprise Ni.

In an embodiment, the one or more respective metal sulfates comprise Mn.

In an embodiment, the one or more respective metal sulfates comprise Co.

In an embodiment, the one or more respective metal sulfates comprise Li.

In preferred embodiments of the third aspect, the process parameters are as defined above in respect of the first and second aspects of the present invention.

In an especially preferred embodiment of the invention, the apparatus as defined in the third aspect of the invention is used to effect the method defined in the first aspect of the invention.

A further aspect of the invention comprises a metal sulfate comprising Mn when produced by the method of the first aspect of the invention.

A further aspect of the invention comprises a metal sulfate comprising Ni when produced by the method of the first aspect of the invention.

A further aspect of the invention comprises a metal sulfate comprising Co when produced by the method of the first aspect of the invention.

A further aspect of the invention comprises a metal sulfate comprising Li when produced by the method of the first aspect of the invention.

### BRIEF DESCRIPTION OF THE DRAWINGS

A preferred embodiment of the present invention will now be described with reference to the accompanying drawings in which:

FIG. 1 is a schematic of the inventive method as defined by the first aspect of the present invention. Specifically, there is provided a method for the extraction of one or more valuable metals from black mass end-of-life battery waste, the method comprising the steps of: a) obtaining the black mass having a content of the one or more valuable metals (represented by “metal” in FIG. 1); b) subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material (represented by “Phase 1” in FIG. 1); and c) converting the sulfur/metal roasted material to its respective metal sulfate/s by subjecting the sulfur/metal roasted material to an extraction medium defined by an excess of water, a flow of air, at a second predetermined temperature, at a second predetermined heated pressure over a second predetermined period (represented by “Phase 2” in FIG. 1).

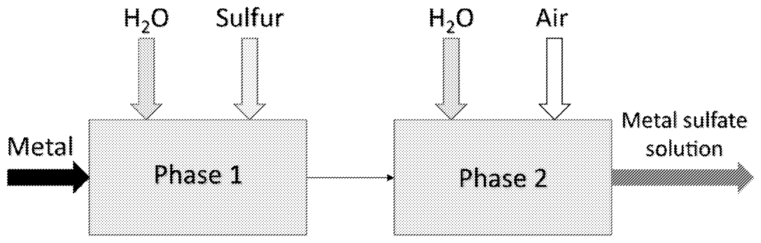

### DETAILED DESCRIPTION OF A PREFERRED EMBODIMENT

In overview, the present invention is perceptibly different to typical pyrometallurgy and hydrometallurgy extraction methods. Herein, the Inventors have utilised a reaction with molten sulfur, in the presence of water and oxygen, in a reaction vessel under pressure to reduce valuable metals such as Co, Ni, Mn and Li. Thereafter, the product mixture undergoes a water leaching process to extract the metal from the sulfur/metal roasted materials as the respective metal sulfate/s. In conception, the present Inventors had suspected there may be a direct reaction between the molten sulfur and the metal oxides present in the black mass. The idea was to circumvent acid production which is a core function of how established acid leaching technologies work.

The present invention relates to a method for the extraction of one or more valuable metals from black mass end-of-life battery waste, the method comprising the steps of:
a) obtaining the black mass having a content of the one or more valuable metals;
b) subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material; and
c) converting the sulfur/metal roasted material to its respective metal sulfate/s by subjecting the sulfur/metal roasted material to an extraction medium defined by an excess of water, a flow of air, at a second predetermined temperature, at a second predetermined heated pressure over a second predetermined period.

The black mass used in step a) is preferably “raw” black mass. Accordingly, the raw black mass comprises one or more valuable metals such as Li, Au, Ag, Al, Ca, Cr, Cu, Fe, Ga, K, Mg, Mn, Na, Si, V, Ni, and Co, electrolytes, binders and the like. In other embodiments, the black mass may be treated to remove or substantially remove the binders, electrolytes, etc. An example of such treatment is a pyrolysis step at or around 700° C.

The black mass used in step a) is preferably shredded, ground and/or milled to an average particle size between about 500 nm and about 500 μm. More preferably, the black mass has an average particle size between about 40 μm and about 60 μm, most preferably about 44 μm.

It will be appreciated that the specific chemical (metal) load of the black mass will be a function of the individual batteries being recycled in each load. For instance, some black mass samples may be relatively rich in lithium whereas others may have a higher loading of, say, manganese, nickel or cobalt.

Step b) requires subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material.

It is believed that unique to the inventive method is the use of elemental sulfur in molten form for the conversion of one or more valuable metals (preferably Li, Mn, Co and/or Ni) at relatively low temperatures. In addition, the method includes supplementing water, which acts to reduce the metal, allowing the reaction to occur at such lower temperatures.

The molar excess of molten elemental sulfur is between about 2:1 and 25:1, preferably about 5:1.

The predetermined amount of water is between about 0.1:1 and 1:1 by mass, preferably about 0.5:1.

The first predetermined temperature is between about 100 and 400° C., preferably about 200° C.

The first predetermined heated pressure is between about 5 and 100 bar, preferably between about 5 and 40 bar, more preferably about 15 bar. In practice, this means that prior to heating, the reaction vessel at ambient temperature is sealed and pressurised to about 5 bar prior to heating.

The first predetermined period is between about 60 and 180 minutes, preferably about 120 minutes.

Optionally, the extraction medium in step b) is further defined by stirring at a rate of about 50 to 500 rpm, preferably about 100 rpm.

Step c) requires converting the sulfur/metal roasted material to its respective metal sulfate/s by subjecting the sulfur/metal roasted material to an extraction medium defined by an excess of water, a flow of air, at a second predetermined temperature, a second predetermined heated pressure over a second predetermined period.

The second method step process consists of water leaching the sulfur/metal roasted valuable metals, which contain mainly metal sulfide materials.

The excess of water is between about 5:1 and 10:1, preferably about 8:1 on a molar ratio of water to sulfur/metal roasted material basis.

The flow of air is achieved either by proving a flow of air over the reaction mixture, or by providing an initial oxygen-rich environment

The second predetermined temperature in step c) is between about 100 and 400° C., preferably about 150° C.

The second predetermined heated pressure in step c) is between about 1 and 100 bar, preferably between about 1 and 20 bar, more preferably about 5 bar.

The second predetermined period in step c) is between about 120 and 240 minutes, preferably about 180 minutes.

In various embodiments, step b) and step c) are conducted in a single vessel. In other embodiments, step b) and step c) are conducted in separate vessels, optionally operatively connected to enable substantially continuous operation.

In other embodiments, the method employs a plurality of vessels arranged in series or parallel, preferably in series. It will be appreciated that the inventive method is adaptable and/or scalable to a continuous flow or batch-type scenario.

Following completion of step c), the resultant metal sulfate/s are filtered from solution, or optionally concentrated prior to such filtration. The metal sulfates may be reduced back to their respective elemental valuable metals via conventional techniques.

The spent black mass is either discarded or subjected to a secondary recycling process, for instance, to recover valuable metals that are not recoverable via the inventive method, electrolytes, binders and the like.

The general method employed above amply demonstrates that mild hydrothermal conditions as an extraction medium for metal sulfates from black mass is surprisingly efficacious. As rationalised above, this finding is completely counter-intuitive given the prevailing state of the art in which strong acids and pre-treatment are the currently-preferred industrial methods for the extraction of valuable metals such as lithium from black mass.

The methodology further demonstrates the efficacy of mild hydrothermal conditions as an extraction medium for other valuable metal recycling from black mass. Such metals preferably include any one or more of Mn, Ni, Co and Li.

### Economic and Environmental Implications

The above examples demonstrate that, contrary to the accepted wisdom of using hydrometallurgical or pyrometallurgical processes to extract valuable metals such as lithium from black mass, such valuable metals can also be extracted under the relatively mild conditions prescribed by the present invention. Such a process engenders many advantages, without the negative consequences in respect of metal selectivity, cost, environmental damage, without the need for one or more pre-treatment or subsequent purification/extraction steps and, in the case of hydrometallurgical processes, without any in-depth understanding of the black mass chemistry.

The inventive method of extracting valuable metals from black mass engenders many advantages over the methods prescribed in the prior art. In using a relatively mild hydrothermal extraction medium at only moderate temperature, pressure—and over a relatively short reaction period, the inventive method is genuinely counterintuitive. Moreover, as compared with the representative prior art methods, the present invention provides for an environmentally-friendly approach to what has traditionally been a somewhat damaging and wasteful pursuit.

More specifically, the use of molten sulfur for the extraction of valuable metals under low heating conditions in the presence of water represents an environmentally-friendly approach compared to many/most known LIB recycling methods.

### INDUSTRIAL APPLICABILITY

With ever-increasing global demand for valuable metals such as lithium, manganese, nickel, and cobalt, set against a finite mineral supply and processing difficulties with traditional extraction methods, recycling is essential. The economic implications of successfully developing and commercialising the inventive technology may be significant.

The concept of using molten elemental sulfur to recycle valuable metals from the black mass of spent lithium-ion batteries into fresh cathode material is clearly demonstrable via the inventive process. Up to 100% conversion of metal oxides into metal sulfates was achieved when performing experiments under mild optimised conditions with individual metal oxides. Up to 35% conversion into metal sulfates and 56% into metal sulfides was achieved when performing experiments under mild suboptimal conditions with a combination of metal oxides. The addition of graphite into as a closer simulation of black mass did not impact the successful conversions observed.

A two-step reaction process was defined, in which the first step was sulfur roasting with superheated water, which involved the reaction of molten sulfur with metal oxides to form a mixture of metal sulfides (major product) and metal sulfates (minor product). The second step was wet oxidation which used excess water to facilitate the conversion of metal sulfides into metal sulfates. The main difference between the optimal conditions for these steps was the amount of water present (low versus high). Optimising these two steps towards convergence could allow either a one-step or one-pot reaction with water introduced progressively.

The conversion rate of metal oxides from simulated black mass may be improved with further process optimisation. This would include increasing the wet oxidation temperature to levels that were not possible with the current experimental apparatus due to the excess production of gaseous by-products.

Although the invention has been described with reference to specific examples it will be appreciated by those skilled in the art that the invention may be embodied in many other forms.

What is claimed is:

1. A method for the extraction of one or more valuable metals from black mass end-of-life battery waste, the method comprising the steps of:
a) obtaining the black mass having a content of the one or more valuable metals;
b) subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material; and
c) converting the sulfur/metal roasted material to its respective metal sulfate/s by subjecting the sulfur/metal roasted material to an extraction medium defined by an excess of water, a flow of air, at a second predetermined temperature, at a second predetermined heated pressure over a second predetermined period.

2. A method according to claim 1, wherein the metal sulfate/s is/are collected and filtered for further processing to convert the metal sulfate/s to their respective elemental metal.

3. A method according to claim 1, wherein the molar excess of molten elemental sulfur is between about 2:1 and 25:1.

4. A method according to claim 1, wherein the predetermined amount of water is between about 0.5:1 and 1:1 by mass with respect to the hydrothermal extraction medium.

5. A method according to claim 1, wherein the first and second predetermined temperatures may be the same or different and are each between about 100 and 400° C.

6. A method according to claim 1, wherein the first and second predetermined heated pressures may be the same or different and are each between about 1 and 40 bar.

7. A method according to claim 1, wherein the first and second predetermined periods may be the same or different and are each between about 60 and 240 minutes.

8. A method according to claim 1, wherein the excess of water in step c) is between about 5:1 and 10:1 on a molar ratio of water to sulfur/metal roasted material basis.

9. A method according to claim 1, wherein step b) and step c) are performed simultaneously.

10. A method according to claim 1, wherein step b) and step c) are conducted in separate vessels, optionally operatively connected to enable substantially continuous operation.

11. A method according to claim 1, wherein the hydrothermal extraction medium is defined by a black mass concentration between about 0.1 and about 60% w/w.

12. A method according to claim 1, wherein the black mass has an average particle size between about 500 nm and about 500 μm.

13. A method according to claim 1, wherein the hydrothermal medium further comprises one or more mineral acids, one or more organic acids, one or more alkaline salts, one or more ionic liquids, and combinations thereof.

14. An apparatus for the extraction of one or more valuable metals from black mass end-of-life battery waste, the apparatus comprising:
a) means for subjecting the black mass to a hydrothermal extraction medium defined by a molar excess of molten elemental sulfur, a predetermined amount of water, a first predetermined temperature and a first predetermined heated pressure, over a first predetermined period to provide a sulfur/metal roasted material; and
b) means for converting the sulfur/metal roasted material to its respective metal sulfate/s by subjecting the sulfur/metal roasted material to an extraction medium defined by an excess of water, a flow of air, at a second predetermined temperature, at a second predetermined heated pressure over a second predetermined period.

15. An apparatus according to claim 14, comprising a plurality of reactors arranged in fluid communication in series.
